(19) United States
(12) Patent Application Publication
(10) Pub. No.: US 2014/0348182 A1
(43) Pub. Date: Nov. 27, 2014

(54) TIME SYNCHRONIZATION BETWEEN NODES OF A SWITCHED INTERCONNECT FABRIC

(71) Applicant: III Holdings 2, LLC, Wilmington, DE (US)

(72) Inventors: Prashant R. Chandra, San Jose, CA (US); Thomas A. Volpe, Austin, TX (US); Mark Bradley Davis, Austin, TX (US)

(21) Appl. No.: 13/899,751

(22) Filed: May 22, 2013

(51) Int. Cl. H04J 3/06

(52) U.S. Cl. CPC H04J 3/0697
USPC 370/503

(57) ABSTRACT

A data processing node includes a local clock, a slave port and a time synchronization module. The slave port enables the data processing node to be connected through a node interconnect structure to a parent node having time-based functionality thereof that is operating in accordance with a fabric time of the node interconnect structure. The time synchronization module is coupled to the local clock and the slave port. The time synchronization module is configured for engaging in a time synchronization message exchange sequence with a node connected to the slave port thereof to collect parent-centric time synchronization information and synchronizing operation of a central processing unit (CPU) structure of the data processing node with the fabric time using the parent-centric time synchronization information.

### BACKGROUND

1. Field of the Invention

Embodiments of the present invention relate to a switched interconnect fabric and nodes thereof. More specifically, embodiments of the present invention relate to implementation of time synchronization between nodes of a switched interconnect fabric such as a cluster of fabric-attached Server on a Chip (SoC) nodes.

2. Description of Related Art

It is well known that time synchronization between a cluster of interconnected nodes (i.e., a distributed system) is important to the effectiveness and accuracy of operation of such nodes. For example, accuracy of time synchronization between nodes (i.e., clocks thereof) affects synchronization of OS schedulers across the fabric. Accordingly, accuracy of time synchronization affects overall system noise and application level latencies.

Several aspects of distributed systems or clusters can be affected by time synchronization. Event tracing, debugging, synchronization between threads running on different systems and the like can all benefit from accurate time synchronization. For example, it is difficult to accurately debug performance problems in a cluster of nodes if time is not accurately synchronized across the nodes (e.g., servers, which can be in the form of a SOC).

Traditionally, time synchronization between a cluster of interconnected nodes has relied upon time synchronization packets being sent/received by software running on the server central processing units (CPUs) of each nodes and on time synchronization computations being performed by the server CPUs of each node. However, when time synchronization is provided as a software-implemented service within the nodes, time synchronization accuracy is adversely impacted due to limitations arising from processing information within the software. For example, providing time synchronization as software-implemented service in accordance with IEEE 1588 (Precision Time Protocol) or IEEE 802.1AS (Timing and Synchronization), time sync packets are generated, received and processed in software such as, for example, an operating system (OS) driver.

Furthermore, in a time synchronization implementation such as that in accordance with IEEE 1588, there are several factors that can contribute to significant computational error and this error can also accumulate over time thereby resulting in loss of accuracy. Examples of such factors include, but are not limited to, using integer representation of timestamp information, using relatively lower frequency clocks (e.g., 25-100 MHz) and not all nodes in a network using clocks of the same frequency. In addition, the variable latency involved in reading timestamps from software has a significant adverse effect on the accuracy of time synchronization.

To achieve improved accuracy when providing time synchronization as a software-implemented service, atomic clocks are sometimes utilized to improve accuracy by providing a relatively consistent chronological baseline (i.e., a common timebase). However, atomic clocks are relatively expensive and, thus, it can be impractical to have one atomic clock per node. Instead, it is common to use one atomic clock per rack of nodes (e.g., servers), which can be counter-productive as this leads to lost time synchronization accuracy.

Accordingly, implementing time synchronization within nodes in a manner that provides for increased accuracy in a cost effective manner would be advantageous, useful and desirable.

### SUMMARY

Embodiments of the present invention are directed to implementation of a time synchronization between nodes (e.g., Server on a Chip (SoC) nodes) of a fabric (e.g., a switched interconnect fabric). The time synchronization is implemented using a distributed service (i.e., a time synchronization service) running on all nodes across the fabric. The time synchronization service provides a mechanism for synchronizing the local clocks of all the nodes across the entire fabric to a high degree of accuracy resulting in a common chronological timeline (i.e., the common timebase), which is referred to herein as fabric time. For example, each node can include a free running clock (i.e., a local clock) and can present the fabric time through a timer interface to one or more processor cores of the node. Use of the fabric time as a system time across all nodes in the fabric allows operating system (OS) schedulers across the fabric to be synchronized, which results in lower overall system noise and more predictable application level latencies.

Time synchronization in accordance with embodiments of the present invention is a hardware-implemented service. More specifically, the time synchronization service is preferably implemented within hardware floating-point computation processors of each one of the nodes. In the context of the disclosures made herein, as discussed below in greater detail, time synchronization being a hardware-implemented service refers to one or more hardware elements of each one of the nodes generating, receiving and processing time sync packets (i.e., packet operations) and to one or more hardware elements of each one of the nodes performing time sync computations (i.e., computation operations). In one embodiment, the packet operations and computation operations are performed by a double-precision floating point unit (e.g., a Time Sync Protocol Engine and a Time Sync Processor, respectively). Implementing the time synchronization as a hardware-implemented service is advantageous because a hardware implementation enables a very high rate of time sync packet exchanges to be sustained, which results in the nodes of the fabric (i.e., a node cluster) converging to a common time much faster than when time synchronization is provided as a software-implemented service.

In one embodiment, a data processing node comprises a local clock a slave port and a time synchronization module. The slave port enables the data processing node to be connected through a node interconnect structure to a parent node that is operating in a time synchronized manner with a fabric time of the node interconnect structure. The time synchronization module is coupled to the local clock and the slave port. The time synchronization module is configured for collecting parent-centric time synchronization information and for using a local time provided by the local clock and the parent-centric time synchronization information for allowing one or more time-based functionality of the data processing node to be implemented in accordance with the fabric time.

In another embodiment, a data processing node comprises a local clock, a slave port, a time synchronization protocol engine, and a time synchronization computation engine. The slave port enables the data processing node to be connected through a node interconnect structure to a parent node having a central processing unit (CPU) structure thereof that is operating in accordance with a fabric time of the node interconnect structure. The time synchronization protocol engine is coupled to the slave port for enabling parent-centric time synchronization information to be collected. A local time of a grandmaster node connected to the node interconnect structure is the fabric time. The time synchronization computation engine is coupled to the time synchronization protocol engine for receiving the parent-centric time synchronization information therefrom and is configured for using a local time of the data processing node provided by the local clock and the parent-centric time synchronization information for allowing the central processing unit (CPU) structure of the data processing node to operate in accordance with the fabric time.

In another embodiment, a data processing system comprises a plurality of data processing nodes each interconnected to each other via a respective fabric switch thereof. One of the data processing nodes is a grandmaster node from which all of the other ones of the data processing nodes subtend with respect to time synchronization. The fabric switch of each one of the data processing nodes that subtend from the grandmaster node comprises a local clock, a slave port, a time synchronization protocol engine, and a time synchronization computation engine. The slave port is connected to another one of the data processing nodes that serves as a parent node thereto. The time synchronization protocol engine is coupled to the slave port for collecting parent-centric time synchronization information. The time synchronization computation engine is coupled to the local clock and the slave port. The time synchronization computation engine uses a local time provided by the local clock and the parent-centric time synchronization information for causing one or more time-based functionality structure thereof to be implemented in accordance with a local time of the grandmaster node.

In another embodiment, a data processing node comprises a local clock, a slave port and a time synchronization module. The slave port enables the data processing node to be connected through a node interconnect structure to a parent node having a central processing unit (CPU) structure thereof that is operating in accordance with a fabric time of the node interconnect structure. The time synchronization module is coupled to the local clock and the slave port. The time synchronization module is configured for engaging in a time synchronization message exchange sequence with a node connected to the slave port thereof to collect parent-centric time synchronization information and synchronizing one or more time-based functionality of the data processing node with the fabric time using the parent-centric time synchronization information.

In another embodiment, a data processing system comprises a plurality of data processing nodes each interconnected to each other through a node interconnect structure. One of the data processing nodes is a grandmaster node from which all of the other ones of the data processing nodes subtend with respect to time synchronization. Each one of the data processing nodes that subtend from the grandmaster node comprises a local clock, a slave port connected to another one of the data processing nodes that serves as a parent node thereto and a time synchronization module coupled to the local clock and the slave port. A time synchronization protocol portion of the time synchronization protocol module performs functions for collecting parent-centric time synchronization information. A time synchronization computation portion of the time synchronization protocol module performs functions for chronologically synchronizing time-based operations of a central processing unit (CPU) structure thereof to a local time of the grandmaster node using a local time provided by the local clock and the parent-centric time synchronization information.

In another embodiment, a method for synchronizing time-based functionality of a plurality of data processing nodes interconnected within a network comprises designating a first one of the data processing nodes as a grandmaster node of the network and designating a time maintained by the grandmaster node as fabric time for the network. All of the other ones of the data processing nodes subtend from the grandmaster node with respect to time synchronization. For each one of the data processing nodes that subtend from the grandmaster node, the method further comprises engaging in a time synchronization message exchange sequence with a node connected to a slave port thereof to collect time synchronization information and synchronizing one or more time-based functionality thereof with the fabric time using the time synchronization information.

These and other objects, embodiments, advantages and/or distinctions of the present invention will become readily apparent upon further review of the following specification, associated drawings and appended claims.

### BRIEF DESCRIPTION OF THE DRAWINGS

FIGS. 1 and 2 show data processing nodes organized into a synchronization hierarchy defined by a spanning tree.

FIGS. 3 and 4 are diagrammatic views showing details of a fabric switch for a local node configured in accordance with an embodiment of the present invention.

FIG. 5 is a flow diagram showing a method for implementing time synchronization in accordance with an embodiment of the present invention.

FIG. 6 is a flow diagram showing a time synchronization message exchange sequence configured in accordance with an embodiment of the present invention.

### DETAILED DESCRIPTION

Embodiments of the present invention are directed to implementation of a time synchronization (sync) protocol entirely or predominately in hardware (HW) of each one of a plurality of data processing nodes in a network. Server on a chip (SoC) nodes that are interconnected within a fabric via a respective fabric switch are examples of a data processing node in the context of the present invention. However, the present invention is not unnecessarily limited to any particular type, configuration, or application of data processing node.

Advantageously, with a HW implementation of time synchronization, a relatively high rate of time sync packet exchanges can be maintained between data processing nodes. This enables an entire cluster of processing nodes to converge to a common time much faster than in a purely software (SW) implementation of time synchronization. Furthermore, a HW implementation of time synchronization provides a mechanism for synchronizing a local clock of each one of a plurality of data processing nodes in a network to a high degree of accuracy thereby resulting all of the data processing nodes operating in accordance with a common timebase. In the case of time synchronization being implemented across a fabric of SoC nodes, the time computed through the time synchronization process can be used as the local time of the SoC. This common timebase is referred to herein as fabric time. Through operation in accordance with the fabric time in all data processing nodes of a network, node elements such as operating system (OS) schedulers across the network are synchronized resulting in lower overall system noise and more predictable application level latencies.

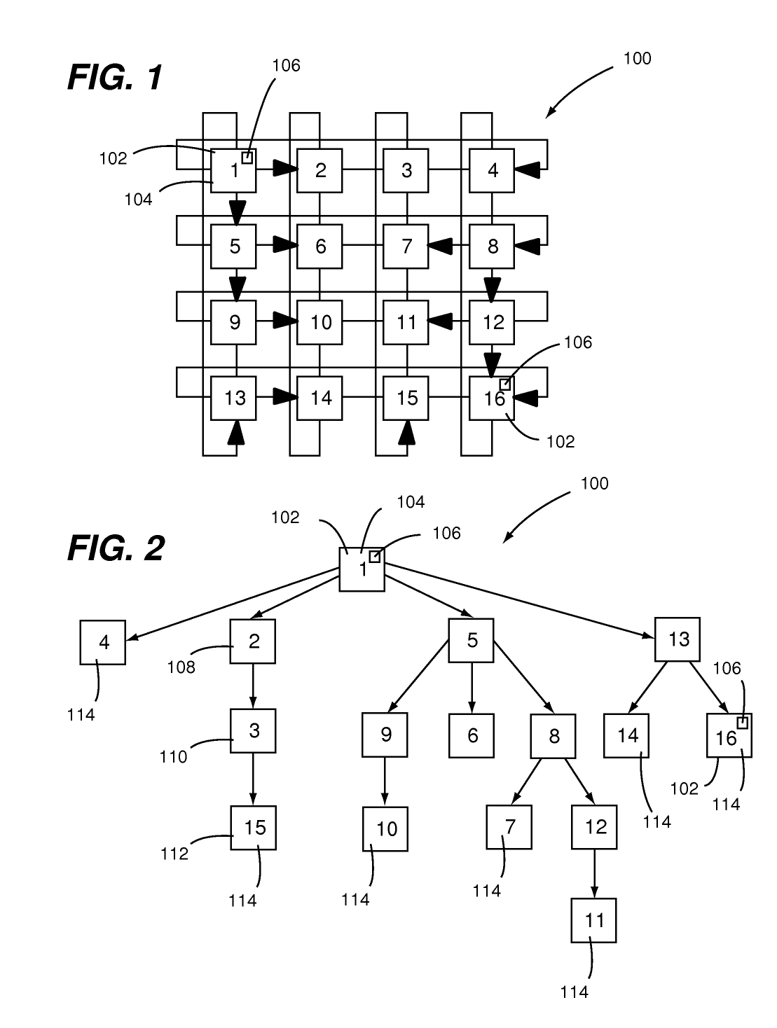

Referring now to FIGS. 1 and 2, a network 100 includes a plurality of data processing nodes 102 (i.e., data processing nodes 1-16). Time synchronization functionality implemented in accordance with embodiments of the present invention is a distributed service running on all data processing nodes across the network (e.g., a SoC switched interconnect (i.e., fabric)) in the case where each one of the data processing nodes is a SoC node). As shown, the data processing nodes 102 are organized into a fabric topology (e.g., a 4×4 2D torus topology shown in FIG. 1) and further organized into a time synchronization hierarchy (shown in FIG. 2) defined by a spanning tree.

A grandmaster (GM) node 104 is at the root of the spanning tree. A local clock 106 of the grandmaster node 104 provides a local time that serves as the fabric time for the local clock 106 of each other data processing nodes 102 in the network 100. It is disclosed herein that the local clock of the grandmaster node 104 can be synchronized to an outside time source using other protocols such as, for example, network time protocol (NTP) or an atomic clock. Fabric management software may designate any node as the grandmaster node and make it the root of the spanning tree.

All of the data processing nodes 102 that directly or indirectly subtend from the grandmaster node 104 (i.e., subtending data processing nodes) are organized into a master-slave synchronization hierarchy. A parent node (e.g., parent node 108) acts as the master and each of its child nodes (e.g., child node 110 and child node 112) that act as a slave. In this respect, the child node is a local node with parent node 108 being its master and child node 112 being its slave. On each particular data processing node 102 in the network 100, time synchronization functionality configured in accordance with the present invention implements a protocol that synchronizes the local clock 106 of a particular one of the data processing nodes 102 to that of its parent node in the spanning tree by exchanging timing messages on a periodic basis (as discussed below in greater detail).

As discussed below in greater detail, the parent node provides time synchronization information to each of its child nodes that act as a slave. Therefore, a particular one of the subtending data processing nodes can simultaneously play the role of a parent node (i.e., a master) and a child node (i.e., a slave). The grandmaster node 104 only plays the role of the master (e.g., has only master ports) and the nodes 102 represented by leaves of the spanning tree (i.e., leaf nodes 114) only play the role of a slave (e.g., slave-only nodes having only have slave ports). All other nodes between the grandmaster node and slave-only nodes have a single slave port and one or more master ports.

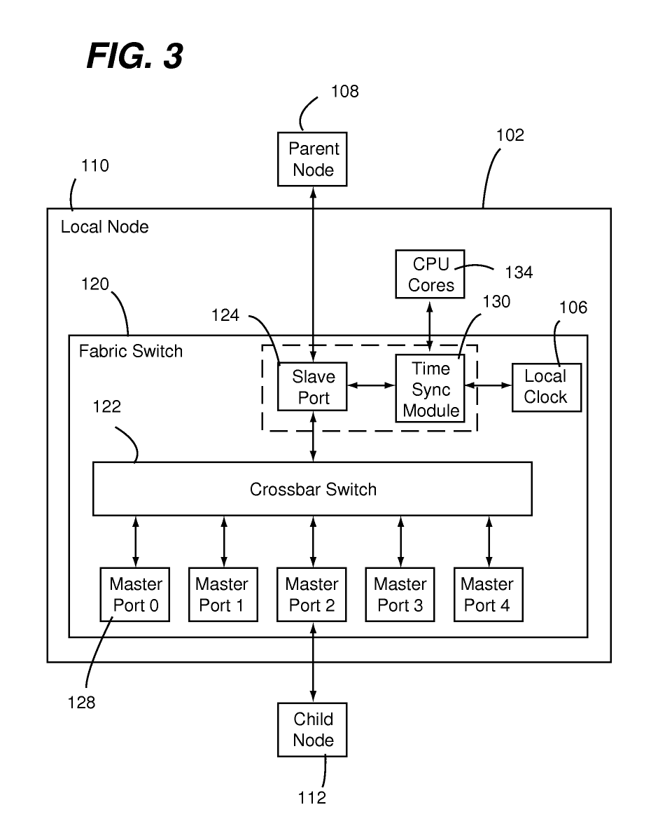

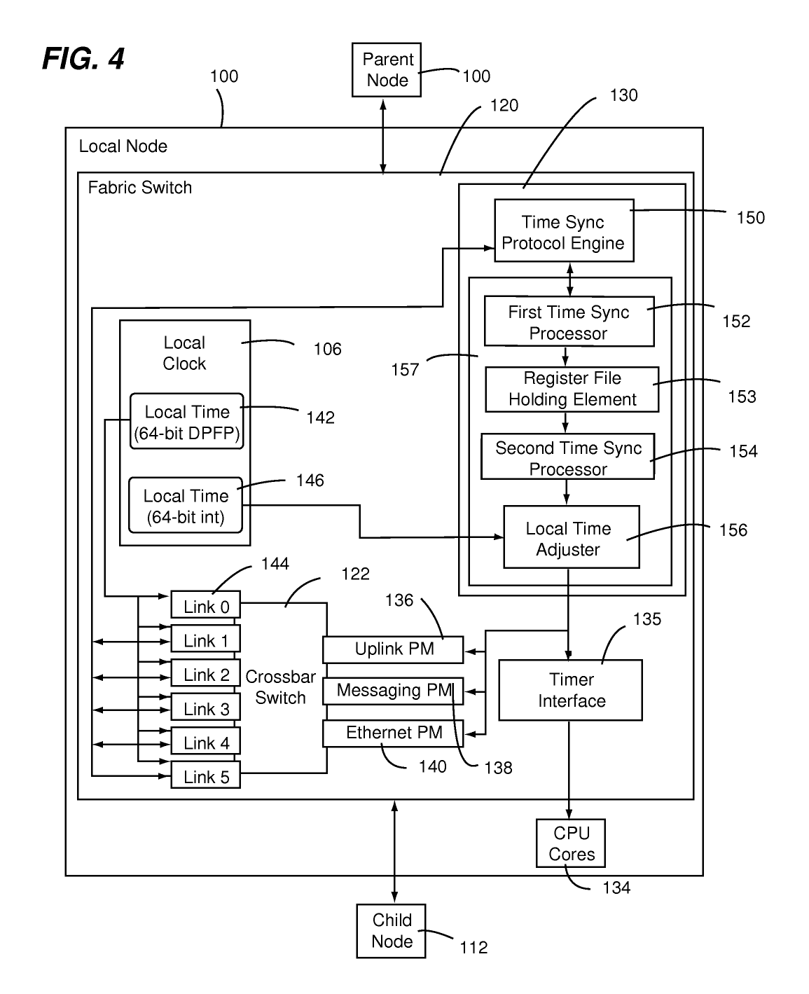

FIGS. 3 and 4 show details of a fabric switch 120 (i.e., node interconnect structure) for the local node 110 shown in FIG. 2. The fabric switch 120 includes a crossbar switch 122, a slave port 124 (i.e., a time sync slave port) and a plurality of master ports 128 (i.e., time sync mater ports), a time sync module 130, and the local clock 106 (also shown in FIGS. 1 and 2). The slave port 124 and the master ports 128 are connected to the crossbar switch 122. In general terms, the crossbar switch is an interconnect structure for connecting multiple inputs to multiple outputs in a matrix manner. The time sync module 130, which can be integral with or otherwise interfaced to slave port 124, is coupled to the local clock 106. A time synchronization protocol of the time sync module 130, which is initiated by the slave ports and runs periodically, defines the format, semantics and processing of timestamp messages exchanged between master and slave ports in the time synchronization hierarchy.

The time sync module 130 is coupled to a central processing unit (CPU) structure 134 of the local node 110 through a low-latency timer interface 135 such as, for example, an ARM Generic Timer Interface. This coupling of the time sync module 130 to the central processing unit (CPU) structure 134 allows fabric time to be provided by the time sync protocol module 130 to the central processing unit (CPU) structure 134 such that the processing unit (CPU) structure 134 can operate in accordance with the fabric time. Additionally, providing fabric time in this manner avoids the uncertainty of reading a “fabric time register” across a variable latency bus such as PCI Express or even an internal SoC interconnect (e.g., AXI format interconnect). Optionally, the time sync module 130 can also be coupled (directly or optionally through the low-latency timer interface 135) to one or more functionality blocks within the fabric switch 120 for use by various other protocols in the fabric switch 120. Examples of the one or more functionality blocks within the fabric switch 130 include, but are not limited to, an Ethernet Personality Module (PM) 136, an Uplink PM 138 and a Messaging PM 140. Personality modules are defined herein to be modules that provide a respective functionality (e.g., Ethernet functionality, uplink functionality, messaging functionality and the like) within a node. It is disclosed herein that functionality provided by the central processing unit (CPU) structure 134, associated management processors, personality modules and the like can be time-based functionalities (i.e., functionality of a node that is dependent on time (e.g., fabric time) maintained at and/or computed within the node).

The local clock 106 is a free running clock that operates in accordance with a particular operating frequency specification. In one particular example, the local clock 106 of the local node 110 (and the local clock of every data processing node in a network with the local node 110) runs at a frequency of 312.5 MHz±100 ppm, is not spread-spectrum modulated, and has an output that increments an 64-bit counter (i.e., a Local Time counter output 142). The Local Time counter 142 value is preferably, but not necessarily, maintained in an IEEE 754 double precision floating-point form (e.g., a sign bit (bit 63), 11 bits for the exponent E (bits 62 down to 52) and 52 bits for the fraction f (bits 51 to 0)) and holds an unsigned nanosecond value where the sign bit is always 0. Using a local clock output having a double-precision floating-point form and uniform local clocks (e.g., 312.5 MHz+/−100 ppm) across all nodes supports nanosecond level accuracy between adjacent nodes. The Local Time counter output 142 is coupled one or more fabric links 144 of the crossbar switch 122. The one or more fabric links 144 of the crossbar switch 122 are also coupled to the time sync module 130. The local clock also has a 64-bit integer output 146 that is coupled directly to the time sync module 130. It is disclosed herein that the local clock 106 having both double precision floating point format and 64-bit integer outputs is beneficial. For example, the integer format supports simplified interfacing to on-chip elements (e.g., the CPU structure 134) and the double precision floating point supports accuracy of calculations, speed of calculations, and ease of use in implementing DSP calculations.

Double precision floating point numerical format is beneficial because it supports a desired level of precision in time synchronization calculations associated with embodiments of the present invention and is convenient for doing fast, complex calculations in hardware. However, in view of the disclosures made herein, a skilled person will appreciate that used of other numerical formats could be used to provide a suitable level of precision in time synchronization calculations associated with embodiments of the present invention while still fast, complex calculations in hardware. Thus, it is disclosed herein that use of double precision floating point numerical format is not a requirement of time synchronization implementations configured in accordance with the present invention.

The time sync module 130 includes a time sync protocol engine 150, a first time sync processor 152, a register file 153, a second time sync processor 154 and a local time adjuster 156. The time sync protocol engine 150 is coupled to the Local Time counter output 142 of the local clock 106 (i.e., through the fabric links 144 of the crossbar switch 122), the master port 128, and the first time sync processor 152. The second time sync processor 154 is coupled to the first time sync processor 152 through the register file 153, thereby allowing the first time sync processor 152 to read to and write from the register file 153 and allowing the second time sync processor 154 to read from the register file 153. In one embodiment, the register file is a set of registers that hold data values. The first time sync processor 152 is writing multiple data values into the registers in the register file 153 and the first time sync processor 154 is reading the data values from the registers in the register file 153. The local time adjuster 156 is coupled between the second time processor 154 and the integer output 146 of the local clock 106. It is disclosed herein that the first time sync processor 152, the second time sync processor 154 and the local time adjuster 156 jointly define a time sync computation engine 157 configured in accordance with an embodiment of the present invention. Furthermore, it is disclosed herein that the time sync protocol engine 150, the first time sync processor 152 and the second time sync processor 154 are hardware floating point computation processors (e.g., are micro-coded double precision floating point Arithmetic and Logic Units (ALUs)) and that information accessed by the first and second time sync processors 152, 154 is accessed from double precision floating point registers. In this regard, time synchronization functionality in accordance with the present invention is implemented in hardware as opposed to software (e.g., time synchronization does not use any CPU cycles from the CPU core structure 134 (or node management processor).

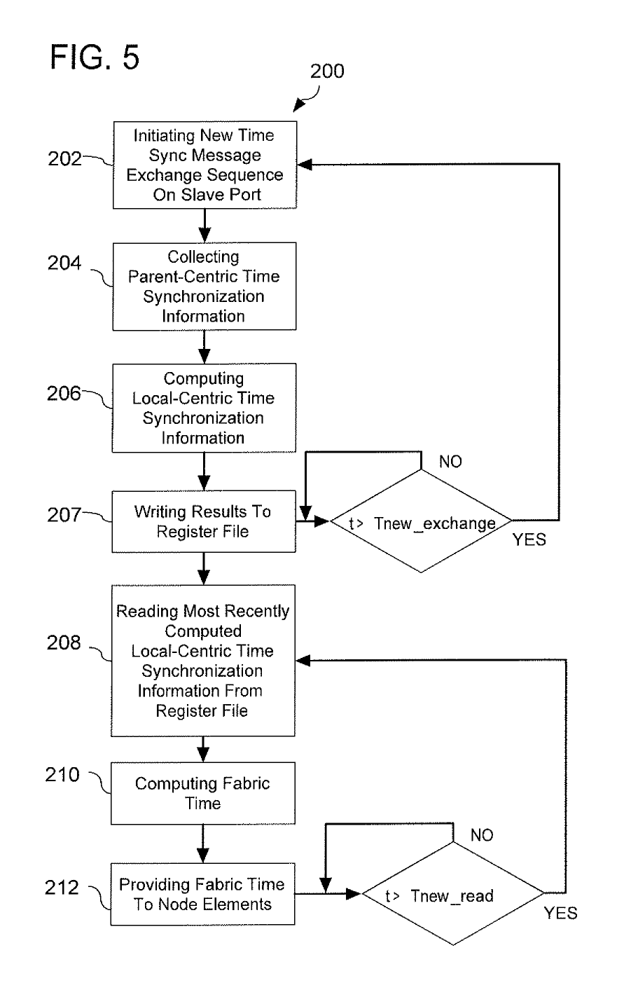

Turning now to FIG. 5, a method 200 for implementing time synchronization in accordance with an embodiment of the present invention is shown. The method 200 will be discussed in the context of the local node 110 of FIGS. 3 and 4. However, in view of the disclosures made herein, a skilled person will appreciate that time synchronization functionality configured in accordance with an embodiments of the present invention is not unnecessarily limited to any particular type, configuration, or application of data processing node.

An operation 202 is performed by the time sync protocol engine 150 for initiating a new time sync message exchange sequence on the slave port 124. In response to initiating the new time sync message exchange sequence, an operation 204 is performed for collecting parent-centric time synchronization information through an instance of the time sync message exchange sequence. As discussed below in greater detail, the purpose of the time sync message exchange sequence is to collect information indicating time and frequency offset between the master and slave local clocks and information indicating time and frequency offset between the grandmaster and master local clocks (jointly referred to herein as the parent-centric time synchronization information). After the time sync protocol engine 150 collects the parent-centric time synchronization information, the first time sync processor 152 performs an operation 206 for computing time synchronization information for the local node (i.e., local-centric time synchronization information) using the parent-centric time synchronization information, followed by an operation 207 for writing the results of the time synchronization information computation (i.e. the parent-centric time synchronization information and the local-centric time synchronization information) to a register file of the register file holding element 153. As shown, this process for initiating the new time sync message exchange, collecting the parent-centric time synchronization information and computing the local-centric time synchronization information is repeated based on a specified period of time elapsing (e.g., a configurable parameter such as Tnew-exchange) or other sequence initiating event or parameter.

Concurrent with instances of the local-centric time synchronization information being computed, the second time sync processor 154 periodically performs (e.g., every clock cycle) operations for enabling fabric time to be locally determined and provided to elements of the local node 110 (e.g., to the CPU core structure 134). To this end, the second time sync processor 154 performs an operation 208 for reading the most recently collected and computed time synchronization information from the register file of the register file 153 (i.e. the parent-centric time synchronization information and the local-centric time synchronization information) and then performs an operation 210 for computing the fabric time using such most recently collected and computed time synchronization information. The second time sync processor 154 performs computations for computing the fabric time as described in the following sections in order to compute the Fabric Time. All of the time sync computations are performed on the slave port. The purpose of the computations is to accurately calculate the time and frequency offsets of a node's local clock relative to grandmaster clock.

Thereafter, the second time sync processor 154 performs an operation 212 for providing the fabric time to the node elements of the local node (e.g., to the CPU core structure 134) such as by adjusting the local time accordingly to be the fabric time via the local time adjuster 156. As shown, this process for reading the most recently computer local-centric time synchronization information, computing the fabric time, and providing the fabric time to the node elements is repeated based on a specified period of time elapsing (e.g., a configurable parameter such as Tnew-read) or other initiating event or parameter. In one specific example, computing of the fabric time is repeated at the conclusion of every local-centric time synchronization information computation instance.

As can be seen, in FIG. 5, there are two time sync information computing processes being carried out concurrently. The operations 202-207 represent a first time sync information computing process of the method 200 that is jointly performed by the time sync protocol engine 150 and the first time sync processor 152. The operations 208-212 represent a second time sync information computing process of the method 200 that is performed by the second time sync processor 154. In this regard, the first time sync information computing process is recomputing time sync info after each instance of a time sync message exchange sequence and the second time sync information computing process is computing the current fabric time at any given moment in time using the most recently computed time synchronization information.

As disclosed above, the first time sync processor 152 is responsible for collected parent-centric time synchronization information. The parent-centric time synchronization information includes a reference time for each one of a plurality of messages within the time synchronization message exchange sequence and includes time synchronization offset information of the local node's parent relative to the grandmaster node. The reference times are collected in the form of timestamps of message passed between the local node and its parent node during each instance of the time synchronization message exchange sequence. The time synchronization offset information of the local node's parent relative to the grandmaster node are values computed at the parent node. Timestamps of messages received by the parent node and the time synchronization offset information of the local node's parent relative to the grandmaster node are transmitted to the local node from the parent node during the time synchronization message exchange sequence.

As disclosed above, the first time sync processor 152 and the second time sync processor 154 can be micro-coded double precision floating point ALUs. Using two ALUs in this manner is advantageous in that it allows the first ALU (i.e., the first time sync processor 152) to do the relatively complex DSP calculations to recomputed offsets based on time sync exchanges while the second ALU (i.e., the second time sync processor 154) to do more simplistic calculations for fast corrections to the local time using the offsets for usage by the CPU and other parts of the chip. A skilled person will appreciate that computations by the second time sync processor 154 may be taking place at a significantly higher rate than the computations by the first time sync processor 152.

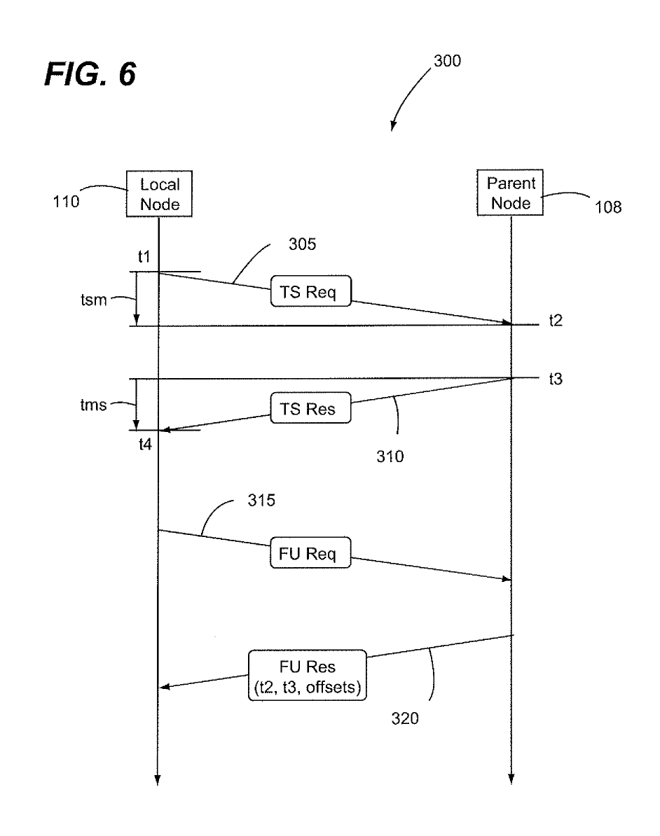

FIG. 6 shows a time synchronization message exchange sequence 300 configured in accordance with an embodiment of the present invention. In response to a time sync protocol engine of a local node initiating the time synchronization message exchange sequence 300, the slave port of the local node takes a first timestamp t1 and transmits a Timestamp Request message 305 to a master port of its parent node. The master port of the parent node takes a second timestamp t2 when it receives the Timestamp Request message 305. In response to receiving the Timestamp Request message 305, the master port of the parent node then takes a timestamp t3 and transmits a Timestamp Response message 310 back to the slave port. The slave port of the local node takes a timestamp t4 when it receives the Timestamp Response message 310. Following the receipt of the Timestamp Response message, the slave port of the local node sends a Follow Up Request message 315 to the master port of the parent node. The master port of the parent node responds to the Follow Up Request message 315 by sending a Follow Up response message 320 to the slave port of the local node. The Follow Up response message 320 contains the measured timestamps t2 and t3 as well as the time and frequency offsets of the master node relative to the grandmaster node (i.e., offsets for local clocks thereof). In this regard, every node in a network (e.g., a fabric switch thereof) maintains the time and frequency offset between its local clock and the grandmaster clock, which is acquired from the parent node's time sync protocol engine by a local node thereof during a time synchronization message exchange sequence.

In preferred embodiments, the slave port of the local node initiates a message exchange by sending a Timestamp Request message at a specified frequency (e.g., TSPeriod times a second). The master port of the parent node transmits the Timestamp Response message as soon as possible after the receipt of the corresponding Timestamp Request message. If any message error occurs (such as CRC failure) anytime during the message exchange, the entire message exchange is voided by ignoring the timestamps from the partially completed message exchange.

As disclosed above, a timestamp is generated when a Timestamp Request or Timestamp Response message is sent or received. The point in the message between the end of the pre-amble and/or start-of-packet delimiter and the beginning of the Timestamp Request/Response message is the called the message timestamp point. Preferably, the timestamp is taken when the message timestamp point passes through a reference plane in the Physical Layer. The reference plane is permitted to be different for transmit and receive paths through the Physical Layer. However, the same transmit reference plane must be used for all transmitted messages and the same receive reference plane must be used for all received messages. The time delay between the reference plane and the message timestamp point is reported through TxDelay and RxDelay Configuration and Status Registers (CSRs) for each fabric link. The timestamps may be generated using the local clock and must have the same format as the Local Time variable. Preferably, the resolution of the timestamp is at least 3.2 ns, which corresponds to a local clock having a 312.5 MHz operating frequency. However, higher precision timestamps are permitted.

At a first level of accuracy (e.g., a relatively low resolution), fabric time (i.e., grandmaster node local time) can be computed at any point in time (t) at the local node by the first time sync processor 152 as follows:

Fabric Time (t)=Local Node Time (t)+Time Offset (t), where Time Offset is the difference between the local node time and the grandmaster node time.

However, in practice, the computations that need to be performed for more accurately determining fabric time require additional complexity. One example of a reason for this additional complexity is the need to compensate for slight differences in the actual frequencies of the local clocks relative to the grandmaster clock. Another example of a reason for this additional complexity is that timestamps taken during a time sync message exchange sequence are taken using different timebases (parent node's clock and local node's clock). Another example of a reason for this additional complexity is that the frequency of the local clock source will drift over time due to temperature, humidity and aging. Still another example of a reason for this additional complexity is that the timestamps collected during message exchange sequence are subjected to asymmetric delays between physical layer transmit and receive paths. Therefore, time sync computations performed in accordance with embodiments of the present invention (e.g., by the first time sync processor 152) preferably, but not necessarily, employ digital signal processing (DSP) techniques (e.g., IIR filters, error estimation, etc) to average out various noise and error sources in the sequence of timestamps and employ corrections for asymmetric delays between transmit and receive paths of the physical layer.

Table 1 below provides nomenclature for variable parameters used in time sync computations performed in accordance with embodiments of the present invention.

TABLE 1
Nomenclature for variable parameters used in time sync computations

| Variable | Definition |
|---|---|
| n | Refers to an iteration of a completed packet exchange between a |
| | slave and a master switch port. |
| N | The number of completed packet exchanges over which the frequency |
| | offset is computed. This variable is configurable by management |
| | software through a CSR. |
| t₁[n] | Timestamp value from the n^{th} packet exchange taken when the |
| | Timestamp Request packet is sent by the slave (i.e., local node). |
| | This timestamp is based on the Local Time counter at the slave |
| | and includes asymmetry corrections performed by the slave. |
| t₂[n] | Timestamp value from the n^{th} packet exchange taken when the |
| | Timestamp Request packet is received by the master (i.e., parent |
| | node). This timestamp is based on the Local Time counter at the |
| | master and includes asymmetry corrections performed by the master. |
| t₃[n] | Timestamp value from the n^{th} packet exchange taken when the |
| | Timestamp Response packet is sent by the master. This |
| | timestamp is based on the Local Time counter at the master and |
| | includes asymmetry corrections performed by the master. |
| t₄[n] | Timestamp value from the n^{th} packet exchange taken when the |
| | Timestamp Response packet is received by the slave. This |
| | timestamp is based on the Local Time counter at the slave and |
| | includes asymmetry corrections performed by the slave. |
| Master_t₄[n] | The value of t₄ obtained at the conclusion of the most recent |
| | packet exchange between the master and its master. |
| fₛₘ[n] | Average frequency offset (i.e., ratio) of the slave clock and its master's |
| | clock (fₛ/fₘ) expressed in master's timebase and computed at |
| | the conclusion of the n^{th} packet exchange. |
| Dₘₛ[n] | Average propagation delay between the slave and the master |
| | expressed in master's timebase and computed at the conclusion |
| | of the n^{th} packet exchange. |
| Tₛₘ[n] | Average time offset between the slave clock and the master |
| | clock computed at the conclusion of the n^{th} packet exchange. |
| A, B, C, D | Low pass filter constants. These constants may be programmed |
| | by software through CSRs. |

As disclosed above, time sync computations performed in accordance with embodiments of the present invention (e.g., by the first time sync processor 152) preferably, but not necessarily, employ corrections for asymmetric delays between transmit and receive paths of the physical layer. To this end, the asymmetry is reported by a fabric switch port through a pair of read-only CSRs: TxDelay and RxDelay. The TxDelay CSR reports the time duration between when a timestamp is taken and when the first bit of the time sync message appears on the wire on transmit. The RxDelay CSR reports the time duration between when the first bit of the time sync message appears on the wire and when the timestamp is taken on receive. The local node (i.e., slave) corrects for asymmetry by performing a series of asymmetry-correcting computations. In one implementation, the series of asymmetry-correcting computations comprises the following:

t1[n]=Timestamp Request sent timestamp+Slave's TxDelay;

t4[n]=Timestamp ACK received timestamp−Slave's RxDelay;

t2[n]=Timestamp Request received timestamp−Master's RxDelay; and

t3[n]=Timestamp ACK sent timestamp+Master's TxDelay.

It is also disclosed above that time sync computations performed in accordance with embodiments of the present invention (e.g., by the first time sync processor 152) preferably, but not necessarily, employ digital signal processing (DSP) techniques to average out various noise and error sources in the sequence of timestamps, thereby improving time synchronization accuracy between nodes. To this end, the local node (i.e., slave) averages out various noise and error sources in the sequence of timestamps by performing a series of digital signal processing (DSP) computations for every packet exchange. In one implementation, the series of DSP computations comprises generating DSP-adjusted frequency offsets, DSP-adjusted propagation delays, and/or DSP-adjusted time offsets. The fabric time at a local node is then computed using the output of these DSP computations. Following are examples of such DSP computations and an associated computation for fabric time that can be implemented by time sync functionality configured in accordance with the present invention (e.g., by the time sync protocol module 130 in FIGS. 3 and 4).

### Frequency Offset DSP Computations

The frequency offset (fₛₘ[iN]) of the slave clock to the master clock can be computed using the following equations:

$${f}_{sm} [ 0 ] = 1$$

$${f}_{sm} [ iN ] = ( 1 - A ) {f}_{sm} [ ( i - 1 ) N ] + A ( \frac{{t}_{1} [ iN ] - {t}_{1} [ ( i - 1 ) N ]}{{t}_{2} [ iN ] - {t}_{2} [ ( i - 1 ) N ]} )$$

$$where$$

$$i = 0 , 12 , 3 …$$

The frequency offset (f_{sg}[iN]) of the slave clock to the grandmaster clock can be computed using the following equation:

f_{sg}[iN]=fₛₘ[iN]×f_{mg}[iN] where i=0,1,2,3, . . .

The reciprocal frequency offset (f_{gs}[iN]) of the grandmaster clock to the slave clock, which is used to avoid division when computing the fabric time, can be computed using the following equation:

$${f}_{gs} [ iN ] = \frac{1}{{f}_{sg} [ iN ]}$$

$$where$$

$$i = 0 , 1 , 2 , 3 , …$$

### Propagation Delay DSP Computations

The propagation delay (Dₘₛ[n]) between the slave and the master can be computed using the following equations:

$${D}_{ms} [ 0 ] = \frac{\{ ( {t}_{4} [ 0 ] - {t}_{1} [ 0 ] ) - ( {t}_{3} [ 0 ] - {t}_{2} [ 0 ] ) \}}{2}$$

$${D}_{ms} [ n ] = ( 1 - B ) {D}_{ms} [ n - 1 ] + B ( \frac{\{ \frac{( {t}_{4} [ n ] - {t}_{1} [ n ] )}{{f}_{sm} [ iN ]} - ( {t}_{3} [ n ] - {t}_{2} [ n ] ) \}}{2} )$$

### Time Offset DSP Computations

The time offset (Tₛₘ[n]) between the slave clock and the master clock can be computed using the following equations:

Xₛₘ[0]=t₃[0]−t₄[0]+Dₘₛ[0]

Xₛₘ[n]=(1−C)Xₛₘ[n−1]+C(t₃[n]−t₄[n]+Dₘₛ[n])

Eₛₘ[0]=0

Eₛₘ[n]=(1−D)Eₛₘ[n−1]+D{Xₛₘ[n]−t₃[n]+t₄[n]−Dₘₛ[n])}

Tₛₘ[n]=Xₛₘ[n]−Eₛₘ[n]

The time offset (Y_{mg}[n]) between the master clock and the grandmaster clock can be computed using the following equation:

$${Y}_{mg} [ n ] = {T}_{mg} [ n ] - ( 1 - \frac{1}{{f}_{mg} [ n ]} ) ( {t}_{3} [ n ] - {Master\_t}_{4} [ n ] )$$

The time offset (T_{sg}[n]) between the slave clock and the grandmaster clock can be computed using the following equation:

$${T}_{sg} [ n ] = {T}_{sm} [ n ] + {Y}_{mg} [ n ] - {D}_{ms} [ n ] ( 1 - \frac{1}{{f}_{mg} [ n ]} )$$

### Fabric Time DSP Computation

The fabric time (T_{f}[t]), which is the time of the grandmaster node at any instant in time (t), can be computed using the following equation:

T_{f}(t)=t₄[n]+T_{sg}[n]+(t−t₄[n])×f_{gs}[n]

Presented now is a brief discussion relating to resilience of time sync functionality configured in accordance with the present invention (e.g., as implemented by the time sync protocol module 130 in FIGS. 3 and 4) in the face of various disruptions in a node interconnect structure (e.g., a fabric in the case of a plurality of SoC nodes). The disruptions may be intentional (e.g. link/node is switched off to save power) or unintentional (e.g., caused by various link or node failures). In either case, there are guidelines can be followed by hardware and node management software (e.g., that of a management engine of a SoC node) to gracefully handle disruptions to the time sync functionality. A first example of such a guideline is that the time sync packet exchange does not gate link power management. The hardware ignores the time sync packet exchange when it computes activity and idle durations for the link for the purposes of automated link power management. A second example of such a guideline is that the node management engine updates the time sync hierarchy when a link or node failure occurs. The node management engine can use a broadcast spanning tree as the time sync spanning tree and update a corresponding time sync hierarchy whenever the broadcast spanning tree is updated. A third example of such a guideline is that, when the grandmaster node dies, the node management engine selects a new root for the time sync hierarchy or a new root for the broadcast spanning tree if the time sync hierarchy is based on the broadcast spanning tree. To this end, the node management engine first sets the local time at the new grandmaster node to the fabric time and then changes the time sync hierarchy across the fabric. This will ensure minimal disruptions to the fabric time when the grandmaster node fails.

A management engine of a SoC node is an example of a resource available in (e.g., an integral subsystem of) a SoC node of a cluster that has a minimal if not negligible impact on data processing performance of the CPU cores. For a respective SoC node, the management engine has the primary responsibilities of implementing Intelligent Platform Management Interface (IPMI) system management, dynamic power management, and fabric management (e.g., including one or more types of discovery functionalities). It is disclosed herein that a server on a chip is one implementation of a system on a chip and that a system on a chip configured in accordance with the present invention can have a similar architecture as a server on a chip (e.g., management engine, CPU cores, fabric switch, etc) but be configured for providing one or more functionalities other than server functionalities.

The management engine comprises one or more management processors and associated resources such as memory, operating system, SoC node management software stack, etc. The operating system and SoC node management software stack are examples of instructions that are accessible from non-transitory computer-readable memory allocated to/accessible by the one or more management processors and that are processible by the one or more management processors. A non-transitory computer-readable media comprises all computer-readable media (e.g., register memory, processor cache and RAM), with the sole exception being a transitory, propagating signal. Instructions for implementing embodiments of the present invention (e.g., functionalities, processes and/or operations associated with time synchronization and the like) can be embodied as portion of the operating system, the SoC node management software stack, or other instructions accessible and processible by the one or more management processors of a SoC unit.

Each SoC node has a fabric management portion that implements interface functionalities between the SoC nodes. This fabric management portion is referred to herein as a fabric switch. In performing these interface functionalities, the fabric switch needs a routing table. The routing table is constructed when the system comprising the cluster of SoC nodes is powered on and is then maintained as elements of the fabric are added and deleted to the fabric. The routing table provides guidance to the fabric switch in regard to which link to take to deliver a packet to a given SoC node. In one embodiment of the present invention, the routing table is an array indexed by node ID.

In view of the disclosures made herein, a skilled person will appreciate that a system on a chip (SoC) refers to integration of one or more processors, one or more memory controllers, and one or more I/O controllers onto a single silicon chip. Furthermore, in view of the disclosures made herein, the skilled person will also appreciate that a SoC configured in accordance with the present invention can be specifically implemented in a manner to provide functionalities definitive of a server. In such implementations, a SoC in accordance with the present invention can be referred to as a server on a chip. In view of the disclosures made herein, the skilled person will appreciate that a server on a chip configured in accordance with the present invention can include a server memory subsystem, a server I/O controllers, and a server node interconnect. In one specific embodiment, this server on a chip will include a multi-core CPU, one or more memory controllers that support ECC, and one or more volume server I/O controllers that minimally include Ethernet and SATA controllers. The server on a chip can be structured as a plurality of interconnected subsystems, including a CPU subsystem, a peripherals subsystem, a system interconnect subsystem, and a management subsystem.

An exemplary embodiment of a server on a chip (i.e. a SoC unit) that is configured in accordance with the present invention is the ECX-1000 Series server on a chip offered by Calxeda incorporated. The ECX-1000 Series server on a chip includes a SoC architecture that provides reduced power consumption and reduced space requirements. The ECX-1000 Series server on a chip is well suited for computing environments such as, for example, scalable analytics, webserving, media streaming, infrastructure, cloud computing and cloud storage. A node card configured in accordance with the present invention can include a node card substrate having a plurality of the ECX-1000 Series server on a chip instances (i.e., each a server on a chip unit) mounted on the node card substrate and connected to electrical circuitry of the node card substrate. An electrical connector of the node card enables communication of signals between the node card and one or more other instances of the node card.

The ECX-1000 Series server on a chip includes a CPU subsystem (i.e., a processor complex) that uses a plurality of ARM brand processing cores (e.g., four ARM Cortex brand processing cores), which offer the ability to seamlessly turn on-and-off up to several times per second. The CPU subsystem is implemented with server-class workloads in mind and comes with a ECC L2 cache to enhance performance and reduce energy consumption by reducing cache misses. Complementing the ARM brand processing cores is a host of high-performance server-class I/O controllers via standard interfaces such as SATA and PCI Express interfaces. Table 2 below shows technical specification for a specific example of the ECX-1000 Series server on a chip.

TABLE 2
Example of ECX-1000 Series server on a chip technical specification

| | |
|---|---|
| Processor Cores | 1. Up to four ARM ® Cortex ™-A9 cores @ 1.1 to |
| | 1.4 GHz |
| | 2. NEON ® technology extensions for multimedia |
| | and SIMD processing |
| | 3. Integrated FPU for floating point acceleration |
| | 4. Calxeda brand TrustZone ® technology for |
| | enhanced security |
| | 5. Individual power domains per core to minimize |
| | overall power consumption |
| Cache | 1. 32 KB L1 instruction cache per core |
| | 2. 32 KB L1 data cache per core |
| | 3. 4 MB shared L2 cache with ECC |
| Fabric Switch | 1. Integrated 80 Gb (8 × 8) crossbar switch with |
| | through-traffic support |
| | 2. Five (5) 10 Gb external channels, three (3) 10 Gb |
| | internal channels |
| | 3. Configurable topology capable of connecting up to |
| | 4096 nodes |
| | 4. Dynamic Link Speed Control from 1 Gb to 10 Gb |
| | to minimize power and maximize performance |
| | 5. Network Proxy Support to maintain network |
| | presence even with node powered off |
| Management | 1. Separate embedded processor dedicated for |
| Engine | systems management |
| | 2. Advanced power management with dynamic |
| | power capping |
| | 3. Dedicated Ethernet MAC for out-of-band |
| | communication |
| | 4. Supports IPMI 2.0 and DCMI management |
| | protocols |
| | 5. Remote console support via Serial-over-LAN |
| | (SoL) |
| Integrated | 1. 72-bit DDR controller with ECC support |
| Memory | 2. 32-bit physical memory addressing |
| Controller | 3. Supports DDR3 (1.5 V) and DDR3L (1.35 V) at |
| | 800/1066/1333 MT/s |
| | 4. Single and dual rank support with mirroring |
| PCI Express | 1. Four (4) integrated Gen2 PCIe controllers |
| | 2. One (1) integrated Gen1 PCIe controller |
| | 3. Support for up to two (2) PCIe x8 lanes |
| | 4. Support for up to four (4) PCIe x1, x2, or x4 lanes |
| Networking | 1. Support 1 Gb and 10 Gb Ethernet |
| Interfaces | 2. Up to five (5) XAUI 10 Gb ports |
| | 3. Up to six (6) 1 Gb SGMII ports (multiplexed |
| | w/XAUI ports) |
| | 4. Three (3) 10 Gb Ethernet MACs supporting IEEE |
| | 802.1Q VLANs, IPv4/6 checksum processing, and |
| | TCP/UDP/ICMP checksum offload |
| | 5. Support for shared or private management LAN |
| SATA | 1. Support for up to five (5) SATA disks |
| Controllers | 2. Compliant with Serial ATA 2.0, AHCI Revision |
| | 1.3, and eSATA specifications |
| | 3. SATA 1.5 Gb/s and 3.0 Gb/s speeds supported |
| SD/eMMC | 1. Compliant with SD 3.0 Host and MMC 4.4 |
| Controller | (eMMC) specifications |
| | 2. Supports 1 and 4-bit SD modes and 1/4/8-bit |
| | MMC modes |
| | 3. Read/write rates up to 832 Mbps for MMC and up |
| | to 416 Mbps for SD |
| System | 1. Three (3) I2C interfaces |
| Integration | 2. Two (2) SPI (master) interface |
| Features | 3. Two (2) high-speed UART interfaces |
| | 4. 64 GPIO/Interrupt pins |
| | 5. JTAG debug port |

While the foregoing has been with reference to a particular embodiment of the invention, it will be appreciated by those skilled in the art that changes in this embodiment may be made without departing from the principles and spirit of the disclosure, the scope of which is defined by the appended claims.

What is claimed is:

1. A data processing node, comprising:
a local clock;
a slave port for enabling the data processing node to be connected through a node interconnect structure to a parent node having time-based functionality thereof that is operating in accordance with a fabric time of the node interconnect structure; and
a time synchronization module coupled to the local clock and the slave port, wherein the time synchronization module is configured for engaging in a time synchronization message exchange sequence with a node connected to the slave port thereof to collect parent-centric time synchronization information and synchronizing one or more time-based functionality of the data processing node with the fabric time using the parent-centric time synchronization information.

2. The data processing node of claim 1 wherein:
the parent-centric time synchronization information includes a reference time for each one of a plurality of messages within the time synchronization message exchange sequence; and
the reference time for each one of the plurality of messages has a double precision floating point configuration.

3. The data processing node of claim 1 wherein:
a second one of the data processing nodes of the network includes a master port having a third one of the data processing nodes of the network connected thereto for enabling the second one of the data processing nodes of the network to serve as a master node and the third one of the data processing nodes of the network to serve as a child node with respect to the master node; and
the time synchronization module is configured for providing locally-derived time synchronization information to the child node to allow the fabric time to be derived at the child node using a local time of the child node and the locally-derived time synchronization information.

4. The data processing node of claim 1 wherein:
the parent-centric time synchronization information includes a reference time for each one of a plurality of messages within the time synchronization message exchange sequence and includes time synchronization offset information of the parent node relative to the grandmaster node; and
synchronizing operation of the one or more time-based functionality includes determining time synchronization offset information relative to the grandmaster node based on each one of the reference times and the time synchronization offset information relative to the grandmaster node and determining the fabric time based on the time synchronization offset information relative to the grandmaster node and a local time provided by the local clock.

5. The data processing node of claim 4 wherein deriving the fabric time includes performing at least one computation that applies at least one low pass filter function to at least one of the reference times.

6. The data processing node of claim 4 wherein the reference time for each one of the plurality of messages has a double precision floating point configuration.

7. The data processing node of claim 4 wherein:
the reference time for each one of the plurality of messages transmitted during the time synchronization message exchange sequence includes a first reference time indicating when a reference time request message was sent, a second reference time indicating when the reference time request message was received, a third reference time indicating when a reference time response message was sent, and a fourth reference time indicating when the reference time response message was received; and
determining the time synchronization offset information relative to the grandmaster node is performed using the reference times.

8. A data processing system, comprising:
a plurality of data processing nodes each interconnected to each other through a node interconnect structure, wherein one of the data processing nodes is a grandmaster node from which all of the other ones of the data processing nodes subtend with respect to time synchronization and wherein each one of the data processing nodes that subtend from the grandmaster node comprises:
a local clock;
a slave port connected to another one of the data processing nodes that serves as a parent node thereto; and
a time synchronization module coupled to the local clock and the slave port, wherein a time synchronization protocol portion of the time synchronization protocol module performs functions for collecting parent-centric time synchronization information and wherein a time synchronization computation portion of the time synchronization protocol module performs functions for chronologically synchronizing time-based operations of a central processing unit (CPU) structure thereof to a local time of the grandmaster node using a local time provided by the local clock and the parent-centric time synchronization information.

9. The data processing system of claim 8 wherein:
the parent-centric time synchronization information includes a reference time for each one of a plurality of messages transmitted between the data processing node and the parent node during a particular one of a plurality of time synchronization message exchange sequences; and
the reference time for each one of the plurality of messages has a double precision floating point configuration.

10. The data processing system of claim 8 wherein:
the parent-centric time synchronization information includes a reference time for each one of a plurality of messages transmitted between the data processing node and the parent node during a particular one of a plurality of time synchronization message exchange sequences and includes time synchronization offset information of the parent node relative to a grandmaster node within the node interconnect structure; and
using the local time provided by the local clock and the parent-centric time synchronization information for allowing the central processing unit (CPU) structure of the data processing node to operate in accordance with the fabric time includes determining time synchronization offset information of the data processing node relative to the grandmaster node based on each one of the reference times and the time synchronization offset information of the parent node relative to a grandmaster node and determining the fabric time based on the time synchronization offset information of the data processing node relative to the grandmaster node and the local time provided by the local clock.

11. The data processing system of claim 10 wherein:
the reference time for each one of the plurality of messages transmitted between the data processing node and the parent node during a particular one of a plurality of time synchronization message exchange sequences includes a first reference time indicating when a reference time request message was sent from the data processing node for reception by the parent node, a second reference time indicating when the reference time request message was received by the parent node, a third reference time indicating when a reference time response message was sent from the parent node for reception by the data processing node, and a fourth reference time indicating when the reference time response message was received by the data processing node; and
determining the time synchronization offset information of the data processing node relative to the grandmaster node is performed using the reference times.

12. The data processing system of claim 11 wherein:
the time synchronization offset information of the parent node relative to the grandmaster node includes a parent-to-grandmaster time offset and a parent-to-grandmaster frequency offset;
determining the time synchronization offset information of the data processing node relative to the grandmaster node using the reference times includes:
determining a frequency offset of the data processing node relative to the parent node using the first reference time and the second reference time;
determining a frequency offset of the data processing node relative to the grandmaster node using the time synchronization offset information of the parent node relative to a grandmaster node and the frequency offset of the data processing node relative to the parent node;
determining a propagation delay of the data processing node relative to the grandmaster node using the frequency offset of the data processing node relative to the parent node and each one of each one of the reference times; and
determining a time offset of the data processing node relative to the parent node using the parent-to-grandmaster time offset, the parent-to-grandmaster frequency offset, the propagation delay, the third reference time and the fourth reference time; and
determining the fabric time at a particular point in time is performed using the parent-to-grandmaster frequency offset, the propagation delay, and the fourth reference time.

13. A method for synchronizing time-based functionality of a plurality of data processing nodes interconnected within a network, comprising:
designating a first one of the data processing nodes as a grandmaster node of the network, wherein all of the other ones of the data processing nodes subtend from the grandmaster node with respect to time synchronization; and
designating a time maintained by the grandmaster node as fabric time for the network,
for each one of the data processing nodes that subtend from the grandmaster node, the method further comprising:
engaging in a time synchronization message exchange sequence with a node connected to a slave port thereof to collect time synchronization information; and
synchronizing one or more time-based functionality thereof with the fabric time using the time synchronization information.

14. The method of claim 13 wherein:
the time synchronization information includes a reference time for each one of a plurality of messages within the time synchronization message exchange sequence; and
the reference time for each one of the plurality of messages has a double precision floating point configuration.

15. The method of claim 13 wherein:
a second one of the data processing nodes of the network includes a master port having a third one of the data processing nodes of the network connected thereto for enabling the second one of the data processing nodes of the network to serve as a master node and the third one of the data processing nodes of the network to serve as a child node with respect to the master node; and
for master node, the method further comprising providing locally-derived time synchronization information to the child node to allow the fabric time to be derived at the child node using a local time of the child node and the locally-derived time synchronization information.

16. The method of claim 13 wherein:
the time synchronization information includes a reference time for each one of a plurality of messages within the time synchronization message exchange sequence and includes time synchronization offset information of the parent node relative to the grandmaster node; and
synchronizing the one or more time-based functionality includes determining time synchronization offset information relative to the grandmaster node based on each one of the reference times and the time synchronization offset information relative to the grandmaster node and determining the fabric time based on the time synchronization offset information relative to the grandmaster node and a local time provided by a local clock thereof.

17. The method of claim 16 wherein deriving the fabric time includes performing at least one computation that applies at least one low pass filter function to at least one of the reference times.

18. The method of claim 16 wherein the reference time for each one of the plurality of messages has a double precision floating point configuration.

19. The method of claim 16 wherein:
the reference time for each one of the plurality of messages transmitted during the time synchronization message exchange sequence includes a first reference time indicating when a reference time request message was sent, a second reference time indicating when the reference time request message was received, a third reference time indicating when a reference time response message was sent, and a fourth reference time indicating when the reference time response message was received; and
determining the time synchronization offset information relative to the grandmaster node is performed using the reference times.
